(19) United States
(12) Patent Application Publication
(10) Pub. No.: US 2026/0175738 A1
(43) Pub. Date: Jun. 25, 2026

(54) BATTERY DEVICE

(71) Applicant: GLOBAL MOBILITY SERVICE INC., Tokyo (JP)

(72) Inventors: Nobuyuki HASHIMOTO, Chiyoda-ku, Tokyo (JP); Koichi HAGISHIMA, Chiyoda-ku, Tokyo (JP); Tokushi NAKASHIMA, Chiyoda-ku, Tokyo (JP)

(21) Appl. No.: 19/129,016

(22) PCT Filed: Apr. 1, 2024
(86) PCT No.: PCT/JP2024/013412

§ 371 Date: May 11, 2025

(30) Foreign Application Priority Data
Apr. 7, 2023 (JP) 2023-063057

(51) Int. Cl. B60L 58/12; B60L 3/00; B60L 53/10; B60L 53/14; B60L 53/65; B60L 53/66

(52) U.S. Cl. CPC B60L 58/12; B60L 3/0046; B60L 53/11; B60L 53/14; B60L 53/65; B60L 53/665; H01M 2220/20

(57) ABSTRACT

The object of the present invention is to enable specification of position information when theft occurs. A battery device according to an embodiment includes: a detection unit that detects that a battery device has been removed from an electric vehicle; and a communication unit that transmits, to a server, position information of the battery device when the detection unit detects that the battery device has been removed from the electric vehicle.

### CROSS-REFERENCE TO RELATED APPLICATIONS

This is a U.S. National Phase Application under 35 U.S.C. § 371 of International Patent Application No. PCT/JP2024/013412, filed on Apr. 1, 2024, which claims priority of Japanese Patent Application No. 2023-063057, filed on Apr. 7, 2023.

### TECHNICAL FIELD

The present invention relates to a battery device.

### BACKGROUND ART

Conventionally, there has been known a technology in which a battery device with a communication function transmits position information to a server to prevent theft of the battery device (see, for example, Patent Literature 1).

### CITATION LIST

### Patent Literature

Patent Literature 1: JP 2002-291110 A

### SUMMARY OF THE INVENTION

However, in the technology according to Patent Literature 1, since the battery device constantly transmits the position information, there is a problem that the position information at the time when the battery device has been removed cannot be specified, and it is not possible to know where the battery device has been stolen.

Therefore, the present invention has been made in view of the above-described problem, and an object thereof is to provide a battery device that enables specification of position information when theft occurs.

A battery device according to an embodiment is summarizes as a battery device mounted on an electric vehicle, the battery device including: a detection unit that detects that the battery device has been removed from the electric vehicle; and a communication unit that transmits, to a server, position information of the battery device when the detection unit detects that the battery device has been removed from the electric vehicle.

According to the present invention, it is possible to provide a battery device that enables specification of position information when theft occurs.

### BRIEF DESCRIPTION OF THE DRAWINGS

FIG. 1 is a diagram illustrating an example of an overall configuration of a control system 100 according to a first embodiment.

FIG. 2 is a diagram illustrating an example of functional blocks of a battery device 10 according to the first embodiment.

FIG. 3 is a flowchart illustrating an example of operation of the control system 100 according to the first embodiment.

### DESCRIPTION OF EMBODIMENTS

Hereinafter, preferred embodiments of the present invention will be described in detail with reference to the accompanying drawings. In the following description of the drawings, the same or similar parts are denoted by the same or similar reference numerals. However, it should be noted that the drawings are schematic, and ratios of dimensions and the like are different from actual ones. Therefore, specific dimensions and the like should be determined in consideration of the following description. In addition, the drawings may include portions having different dimensional relationships and ratios. In the present specification and the drawings, elements having substantially the same function and configuration are denoted by the same reference numerals, and redundant description is omitted, and elements not directly related to the present invention are not illustrated.

### First Embodiment

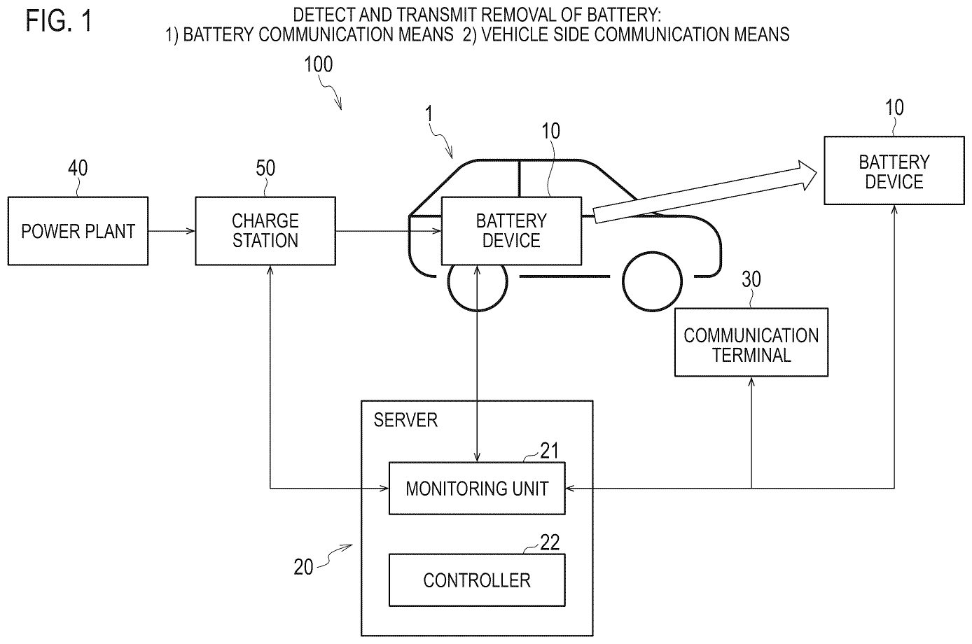

Hereinafter, a control system 100 according to a first embodiment of the present invention will be described with reference to FIGS. 1 to 3.

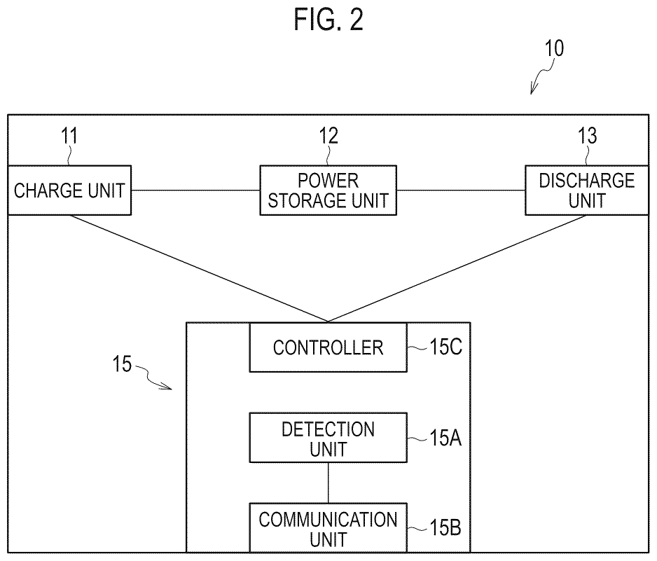

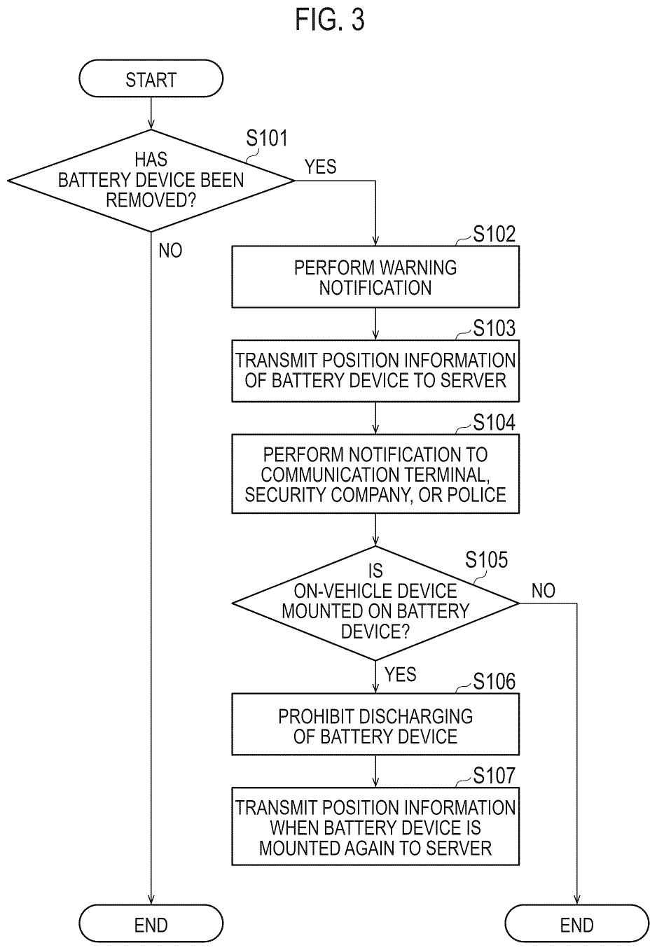

FIG. 1 is a diagram illustrating an example of an overall configuration of the control system 100 according to the present embodiment, FIG. 2 is a diagram illustrating an example of functional blocks of a battery device 10 according to the present embodiment, and FIG. 3 is a flowchart illustrating an example of operation of the control system 100 according to the present embodiment.

The control system 100 according to the present embodiment is configured for the purpose of preventing theft of an electric vehicle (EV) 1.

As illustrated in FIG. 1, a service provision system 100 according to the present embodiment includes the battery device 10 mounted on the electric vehicle 1, a server 20, a communication terminal 30, a power plant 40, and a charge station 50.

In the present embodiment, the electric vehicle 1 may include a hybrid electric vehicle (HEV), a plug-in hybrid vehicle (PHV), a fuel cell vehicle (FCV), and the like.

In addition, the electric vehicle 1 is not particularly limited as long as it is a vehicle (examples thereof include construction equipment and agricultural equipment) that can be driven by wheels, a caterpillar, or the like, and may be, for example, a two-wheeled vehicle, a three-wheeled vehicle, or a six-wheeled vehicle in addition to a normal four-wheeled vehicle.

In addition, the electric vehicle 1 may include a vehicle capable of unmanned travel (Level 4: fully automated driving under specific conditions, level 5: fully automated driving) by remote control.

As illustrated in FIG. 1, electric devices such as a drive device, a headlight, a car stereo, and an air conditioner, electronic devices such as various electronic control units (ECUs) and telematics control units (TCUs), various harnesses, and the like are mounted on the electric vehicle 1, in addition to the battery device 10.

The drive device is configured to be activated by performing an activation operation when a predetermined condition is satisfied. Here, the drive device is a motor.

For example, as the predetermined condition, it is assumed that a shift lever is in a parking range, a brake is stepped on, and the like. In addition, the predetermined condition may include that an encryption key included in the electric vehicle 1 matches an encryption key in a predetermined application, that the communication terminal 30 is in the electric vehicle 1, that a distance between the electric vehicle 1 and the communication terminal 30 is within a certain range, and the like.

Furthermore, as the activation operation, an operation of inserting a key by a driver and rotating, an operation of pressing a start switch, an operation of pressing a button of an application (digital key) installed in a smartphone as the communication terminal 30, and the like are assumed.

As the communication terminal 30, a portable communication terminal such as a smartphone is assumed. Although not specifically illustrated, a configuration of the communication terminal 30 includes, for example, a CPU that executes an application downloaded from the server 20 and controls execution of communication via near field communication, WiFi, mobile phone line communication, or the like, a screen on which execution content of the application is displayed, a GPS that detects position information, an input unit that receives user input, a speaker that outputs sound, and the like.

The power plant 40 is configured to generate power and transmit the power to the charge station 50. The power plant 40 may be a thermal power plant, a nuclear power plant, a wind power plant, or the like, or may be a solar power generation system.

The charge station 50 is configured to charge the battery device 10 mounted on the electric vehicle 1 via a charge plug.

As illustrated in FIG. 2, the battery device 10 includes a charge unit 11, a power storage unit 12, a discharge unit 13, and an on-vehicle device 15.

The charge unit 11 is configured to acquire electricity via the charge plug at the charge station. The power storage unit 12 is configured to store the electricity obtained by the charge unit 11. The discharge unit 13 is configured to discharge the electricity stored in the power storage unit 12 to various circuits of the electric vehicle 1.

As illustrated in FIG. 2, the on-vehicle device 15 includes a detection unit 15A, a communication unit 15B, and a controller 15C. Note that the on-vehicle device 15 may be provided in other than the battery device 10.

The detection unit 15A is configured to detect that the battery device 10 is removed from the electric vehicle 1.

For example, the detection unit 15A may be configured to sense vibration in electric vehicle 1 to detect that battery device 10 has been removed from electric vehicle 1.

Alternatively, the detection unit 15A may be configured to detect disconnection between the electric vehicle 1 and the battery device 10 to detect that the battery device 10 has been removed from the electric vehicle 1.

The communication unit 15B is configured to be able to communicate with the server 20, the communication terminal 30, and the charge station 50.

In addition, the communication unit 15B may be configured to be able to collect vehicle information of the installed electric vehicle 1.

Here, the vehicle information desirably includes a position of the shift lever, detection information indicating whether the brake is stepped on, position information of the vehicle by the GPS, and the like.

The communication unit 15B may be configured to be able to transmit the collected vehicle information to the server 20 via a radio network and receive a control signal from the server 20 via the radio network.

Here, the communication unit 15B is configured to transmit, to the server 20, position information of the battery device 10 when the detection unit 15A detects that the battery device 10 has been removed from the electric vehicle 1.

Alternatively, the communication unit 15B may be configured to store the position information of the battery device 10 when the detection unit 15A detects that the battery device 10 has been removed from the electric vehicle 1, and transmit, to the server 20, the position information of the battery device 10 at a predetermined timing. For example, the communication unit 15B may be configured to transmit, to the server 20, the position information of the battery device 10 in a case where the battery device 10 is not mounted again on the electric vehicle 1 until a predetermined time elapses after the detection unit 15A detects that the battery device 10 has been removed from the electric vehicle 1.

In addition, the communication unit 15B may be configured to transmit the position information of the battery device 10 to at least one of the communication terminal 30 of a user of the electric vehicle 1, a security company, and the police.

Here, the communication unit 15B may be configured to confirm a transmission destination of the position information of the battery device 10 with the server 20, and transmit the position information of the battery device 10 to the transmission destination (for example, the communication terminal 30 of the user of the electric vehicle 1, a server of the security company, a server of the police, and the like) notified from the server 20.

According to such a configuration, it is possible to immediately notify the user, the security company, the police, and the like of a fact that the battery device 10 has been stolen, and it is possible to increase a possibility that the battery device 10 can be recovered.

In addition, the communication unit 15B may be configured to periodically transmit the position information of the battery device 10 after the detection unit 15A detects that the battery device 10 has been removed from the electric vehicle 1.

According to such a configuration, a position of the stolen battery device 10 can be tracked.

Moreover, the communication unit 15B may be configured to transmit, to the server 20, position information of the battery device 10 when the battery device 10 is attached to an electric vehicle other than the electric vehicle 1.

Specifically, the communication unit 15B may be configured to transmit, in a case where the detection unit 15A detects attachment to an electric vehicle other than the electric vehicle 1 corresponding to the battery device 10, the position information of the battery device 10 at that time to the server 20. In such a case, the communication unit 15B may be configured to also transmit the position information to at least one of the communication terminal 30 of the user of the electric vehicle 1, the security company, and the police.

Here, the electric vehicle 1 corresponding to the battery device 10 may be managed by the server 20 or may be managed by the battery device 10. For example, in the former case, the detection unit 15A may confirm with the server 20: via the communication unit 15B whether the electric vehicle to which the battery device 10 is attached is the electric vehicle 1 corresponding to the battery device 10.

According to such a configuration, by tracking the electric vehicle to which the stolen battery device 10 is attached, the battery device 10 can be tracked.

The controller 15C is configured to be able to control the electric vehicle 1 on the basis of the control signal or the like from the server 20 acquired by the communication unit 15B. For example, the controller 15C has a control function of performing activation control or the like of the above-described drive device on the basis of the control signal or the like.

In addition, the controller 15C may be configured to control whether to prohibit charging or discharging of the battery device 10. Here, the controller 15C may be configured to control whether to prohibit charging or discharging of the battery device 10 on the basis of an instruction from the server 20.

Note that, the controller 15C may be configured to suppress, in a case where the battery device 10 is attached to an electric vehicle other than the electric vehicle 1, discharging to the electric vehicle other than the electric vehicle 1.

According to such a configuration, even if the stolen battery device 10 is attached to an electric vehicle (for example, an electric vehicle as a stolen vehicle or the like) other than the electric vehicle 1 corresponding to the battery device 10, discharging is not performed, and therefore, it is meaningless to steal the battery device 10.

Moreover, the controller 15C is configured to be able to set activation of the above-described drive device to either enabled or disabled.

Here, the controller 15C may be configured to set, in a case where the battery device 10 is attached to an electric vehicle other than the electric vehicle 1, activation of a drive device of the electric vehicle other than the electric vehicle 1 to be disabled.

As illustrated in FIG. 1, the server 20 includes a monitoring unit 21 and a controller 22.

The monitoring unit 21 is configured to monitor position information of the battery device 10 mounted on the electric vehicle 1 of each user, so that it is possible to monitor occurrence of theft of the battery device 10 and track a position of the stolen battery device 10.

Here, the monitoring unit 21 may be configured to manage the electric vehicle 1 corresponding to each battery device 10.

The controller 22 is configured to determine whether to prohibit charging or discharging of the battery device 10 mounted on the electric vehicle 1.

For example, in a case where it can be determined that the battery device 10 is stolen by acquiring the above-described position information of the battery device 10, the controller 22 may instruct the on-vehicle device 15 to prohibit charging or discharging of the battery device 10 mounted on the electric vehicle 1.

Note that, the charge station 50 may be configured to, in a case where an electric vehicle to which the stolen battery device 10 is attached is to be charged at the charge station 50, disable the charging of the electric vehicle and notify the server 20, the communication terminal 30 of the user, the security company, the police, and the like that the electric vehicle is in the charge station 50.

Hereinafter, an example of operation of the service provision system 100 according to the present embodiment will be described with reference to FIG. 3.

As illustrated in FIG. 3, when it is detected in step S101 that the battery device 10 has been removed from the electric vehicle 1, the present operation proceeds to step S102.

In step S102, the battery device 10 or another function of the electric vehicle 1 performs warning notification.

The battery device 10 transmits, in step S103, position information at this time to the server 20, and transmits, in step S104, the position information to at least one of the communication terminal 30 of a user of the electric vehicle 1, a security company, and the police.

In a case where the on-vehicle device is mounted (YES in step S105), the battery device 10 sets, in step S106, discharging to be prohibited, and in a case where the on-vehicle device 15 is mounted on an electric vehicle other than the electric vehicle 1, the battery device 10 transmits, in step S107, position information at that time to the server 20.

According to the present embodiment, it is possible to specify the position information when the battery device 10 is stolen.

In addition, according to the present embodiment, even after the battery device 10 is removed from the electric vehicle 1, it is possible to track the battery device 10 and to suppress use in the another electric vehicle 1.

Note that, in a subscription service related to an electric vehicle, by using the battery device 10 according to the present embodiment, it is possible to prevent theft of the battery device 10 mounted on the electric vehicle 1 used by a user of the subscription service, and to safely provide the subscription service.

At least one of a subscription service of the electric vehicle (EV) 1, a subscription service of the battery device 10, and a subscription service of a charge service of the battery device 10 is included.

Here, the subscription service of the electric vehicle 1 is a service that a user can rent and use the electric vehicle 1 on a flat-rate basis. Note that, in the subscription service of the electric vehicle 1, an available vehicle type, an available time, and the like of the electric vehicle 1 change depending on a rate type.

In addition, the subscription service of the battery device 10 is a service that a user can rent and use the battery device 10 that can be mounted on the electric vehicle 1 on a flat-rate basis. In the case of using the subscription service of the battery device 10, the user needs to prepare the electric vehicle 1 by himself/herself. Note that, in the subscription service of the battery device 10, a type, a replacement timing, and the like of the available battery device 10 change depending on a rate type.

Moreover, the subscription service of the charge service of the battery device 10 is a service that a user can charge the battery device 10 mounted on the electric vehicle 1 on a flat-rate basis. In the case of using the subscription service of the charge service of the battery device 10, the user needs to prepare the electric vehicle 1 and the battery device 10 by himself/herself. Note that, in the subscription service of the charge service of the battery device 10, the number of chargeable times (the number of times of quick charging) and the like change depending on a rate type.

Although the present invention has been described in detail using the above-described embodiments, it is apparent to those skilled in the art that the present invention is not limited to the embodiments described herein. The present invention can be implemented as modifications and variations without departing from the spirit and scope of the present invention defined by the description of the claims. Therefore, the description of the present specification is for the purpose of illustration and does not have any restrictive meaning to the present invention.

1. A battery device mounted on an electric vehicle, the battery device comprising:
a detection unit that detects that the battery device has been removed from the electric vehicle; and
a communication unit that transmits, to a server, position information of the battery device when the detection unit detects that the battery device has been removed from the electric vehicle.

2. The battery device according to claim 1, wherein
the communication unit transmits the position information of the battery device to at least one of a communication terminal of a user of the electric vehicle, a security company, and the police.

3. The battery device according to claim 1, wherein
the communication unit periodically transmits the position information of the battery device after the detection unit detects that the battery device has been removed from the electric vehicle.

4. The battery device according to claim 1, wherein
the communication unit transmits, to the server, position information of the battery device when the battery device is attached to an electric vehicle other than the electric vehicle.

5. The battery device according to claim 1, further comprising a controller that suppresses, in a case where the battery device is attached to an electric vehicle other than the electric vehicle, charging or discharging to the electric vehicle other than the electric vehicle.
